(19) United States
(12) Patent Application Publication
(10) Pub. No.: US 2017/0076080 A1
(43) Pub. Date: Mar. 16, 2017

(54) METHOD AND SYSTEM FOR PROCESSING INPUT FINGERPRINT INFORMATION, AND MOBILE TERMINAL THEREOF

(71) Applicant: Shenzhen Huiding Technology Co., Ltd., Shenzhen (CN)

(72) Inventors: Qiyi HAO, Shenzhen (CN); Chiu-po HUNG, Shenzhen (CN)

(21) Appl. No.: 15/343,198

(22) Filed: Nov. 3, 2016

Related U.S. Application Data
(63) Continuation of application No. PCT/CN2015/073908, filed on Mar. 9, 2015.

(30) Foreign Application Priority Data
Oct. 11, 2014 (CN) 201410534375.6

(51) Int. Cl. G06F 21/32

(52) U.S. Cl. CPC G06F 21/32

(57) ABSTRACT

The present disclosure discloses a method and system for processing input fingerprint information, and a mobile terminal thereof. The method includes the following steps: a fingerprint information identification step: when it is scanned that fingerprint information is input, identifying whether a fingerprint template matching with the input fingerprint information is present in a fingerprint database, wherein the fingerprint database includes a plurality of pre-registered fingerprint templates, each fingerprint template being associated with an application operation; and an operation execution step: if it is identified that a fingerprint template matching with the input fingerprint information is present in the fingerprint database, performing the application operation associated with the identified fingerprint template. According to the present disclosure, a plurality of fingerprints is pre-registered as a fingerprint template, and then an application operation is set to be associated with each fingerprint template.

### CROSS REFERENCE TO RELATED APPLICATIONS

The present application is a continuation of international application No. PCT/CN2015/073908, filed on Mar. 9, 2015, which claims priority to Chinese Patent Application No. 201410534375.6, filed on Oct. 11, 2014, both of which are hereby incorporated by reference in its entireties.

### TECHNICAL FIELD

The present disclosure pertains to the field of fingerprint identification, and in particularly, relates to a method and a system for processing input fingerprint information, and a mobile terminal.

### BACKGROUND

In modern life, people are more and more dependent on mobile phones, and are imposing higher and higher requirements on convenience, responsiveness and security of the mobile phones.

For example, the mobile phones are currently provided with various APPs (applications), and some APPs are less frequently used, for example, the photographing APP. However, sometimes, we need to quickly start the photographing APP from a standby screen-off state to take photos. In this case, a high requirement is imposed on the convenience and responsiveness of the startup of the photographing APP. Therefore, if such applications can be started more quickly, a better experience may be brought to users. In recent years, iPhones highly promote application of the fingerprint identification technology in mobile terminals. At present, many mobile phone manufacturers are starting their deployment of products supporting finger print identification.

With the increasing requirements of users, the fingerprint technology is not constrained to such aspects as unlocking and the like. How to attain a more convenient, quicker and funny use experience is an innovation development trend for the fingerprint technology. In addition, modern people highly concern about their privacies, and when the mobile phones have to be lent to others, some applications which are not to be used by others in the mobile phones may bring about unnecessary troubles or embarrassments.

Therefore, mobile phones that are improved in terms of convenience, responsiveness, security, privacy protection and the like would be more populated by consumers.

### SUMMARY

A method for processing input fingerprint information, wherein the method includes the following steps:

a fingerprint information identification step: when it is scanned that fingerprint information is input, identifying whether a fingerprint template matching with the input fingerprint information is present in a fingerprint database, wherein the fingerprint database comprises a plurality of pre-registered fingerprint templates, each fingerprint template being associated with an application operation; and

an operation execution step: if it is identified that a fingerprint template matching with the input fingerprint information is present in the fingerprint database, performing the application operation associated with the identified fingerprint template.

### BRIEF DESCRIPTION OF THE DRAWINGS

FIG. 1 is a flowchart of a method for processing input fingerprint information according to an embodiment of the present disclosure; and

FIG. 2 is a structural principle diagram of a system for processing input fingerprint information according to an embodiment of the present disclosure.

### DETAILED DESCRIPTION

In order to make the objectives, technical solutions, and advantages of the present disclosure clearer, the present disclosure is further described in detail below by reference to the embodiments and the accompanying drawings. It should be understood that the embodiments described here are only exemplary ones for illustrating the present disclosure, and are not intended to limit the present disclosure.

In the present disclosure, a plurality of fingerprints is pre-registered as fingerprint templates respectively, and then each fingerprint template is configured to be associated with a corresponding application operation (for example, an software application or function). In this way, after it is scanned that fingerprint information is input by a user, a matching operation is performed between the input fingerprint information and the fingerprint templates. If a fingerprint template matches with the fingerprint information, the associated application operation may be directly performed. This may be specifically applicable to such mobile terminals supporting the fingerprint identification function as mobile phones, PDAs, iPads and the like. Further, the fingerprint template further includes fingerprint orientation information, and during the matching operation, when the orientation of the input fingerprint information is consistent with the fingerprint orientation information of the fingerprint template, the associated application operation is performed.

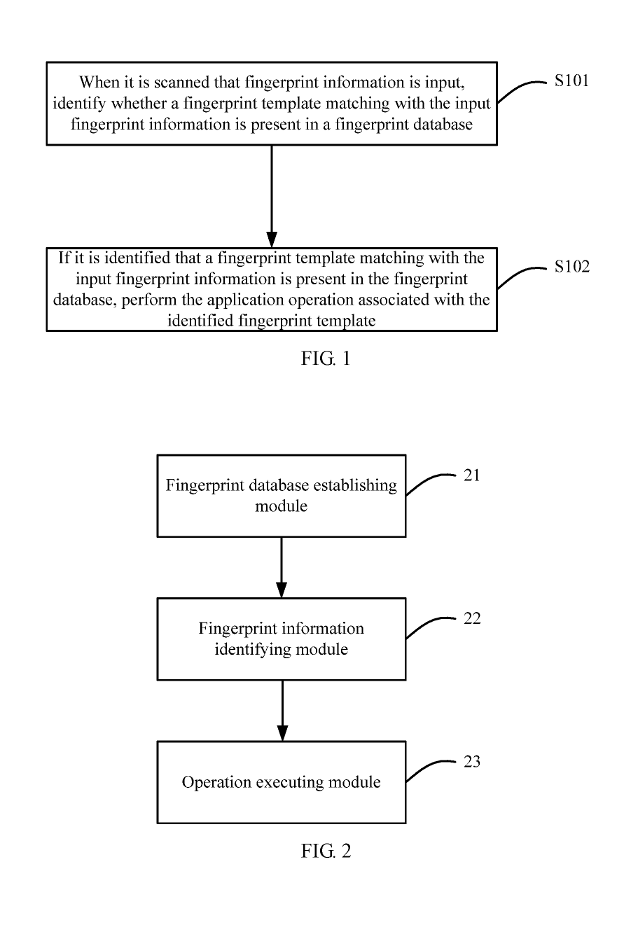

FIG. 1 is a flowchart of a method for processing input fingerprint information according to an embodiment of the present disclosure, which is described in detail hereinafter.

In step S101, identification of fingerprint information is mainly performed; when it is scanned that fingerprint information is input, it is identified whether a fingerprint template matching with the input fingerprint information is present in a fingerprint database, wherein each fingerprint template is associated with a corresponding application operation.

In the embodiment of the present disclosure, a user needs to pre-register a plurality of fingerprint templates, each fingerprint template includes regular fingerprint information; and each fingerprint template is set to be associated with a corresponding application operation, wherein the application operation may be an APP application, a working mode application, a dialup application, an operating system application, a system theme application, or the like. This step may be performed in a screen-on state, a standby screen-off state, an unlocked state, or a locked state of the mobile terminal.

Further, each fingerprint template further includes fingerprint orientation information. A same fingerprint with different orientations may be associated with different application operation.

In step S102, the specific application operation is performed; if it is identified that a fingerprint template matching with the input fingerprint information is present in the fingerprint database, the application operation associated with the identified fingerprint template is performed.

When the fingerprint template includes the fingerprint orientation information, if it is scanned that fingerprint information is input, it is identified whether a fingerprint template matching with both the input fingerprint information and the orientation information thereof is present in the fingerprint database.

As described above, step S101 may be performed in either the screen-on state or the standby screen-off state of the mobile terminal; and when this step is performed in the standby screen-off state, in step S102, the screen needs to be firstly lit up and then the application operation associated with the fingerprint template is performed.

Hereinafter, the specific principle of step S102 is described by taking the APP application, the working mode application, the dialup application, the operating system or the system theme application as an example.

With respect to the APP application, if it is identified that a fingerprint template matching with the input fingerprint information is present in the fingerprint database, the APP application associated with the identified fingerprint template is started. Further, an upward touch, a downward touch, a leftward touch and a rightward touch of the finger relative to a fingerprint sensor may be respectively identified, and be associated with different APP applications.

When a mobile phone is in a screen-off state, the screen is directly lit up and a photographing software is opened after a finger 1 that has been registered upwardly touches the fingerprint sensor. A browser is directly launched after the finger 1 leftwardly touches the fingerprint sensor. It should be understood that this embodiment is not limited to the photographing software, and the finger's touch orientation is not limited to the upward touch, the leftward touch, the rightward touch and the downward touch. The user may associate different orientations of a registered fingerprint with different APP applications, to reach the objective of quick startup.

When the mobile phone is in a screen-on state, the photographing software is opened after the finger 1 that has been registered touches upwardly the fingerprint sensor. A browser is directly launched after the finger 1 leftwardly touches the fingerprint sensor. Likewise, this embodiment is not limited to the photographing software, and the finger's touch orientation is not limited to upward touch, leftward touch, rightward touch and downward touch. The user may associate different orientations of a registered fingerprint with different APP applications, to reach the objective of quick startup.

With respect to the working mode application, in the embodiment of the present disclosure, the working mode includes an owner mode and a non-owner mode having different authorities. If it is identified that a fingerprint template matching with the input fingerprint information is present in the fingerprint database and the fingerprint information corresponds to the owner mode, the owner mode is entered; if it is identified that a fingerprint template matching with the input fingerprint information is present in the fingerprint database and the fingerprint information corresponds to the non-owner mode, the non-owner mode is entered. If it is identified that no fingerprint template matching with the input fingerprint information is present in the fingerprint database, the system is not entered or a predetermined system mode is entered. Further, an upward touch, a downward touch, a leftward touch and a rightward touch of the finger relative to a fingerprint sensor may respectively start or switch to different system mode.

The system of the mobile phone may be set to different system modes according to privacy or security levels, for example, a user mode and a guest mode (this embodiment is not limited to these system modes). Each mode has different usage authorities. For example, some files may not be viewed or may be invisible in the guest mode (or in other non-owner usage modes); or some APPs may not be opened or may be invisible in the guest mode (or in other non-owner usage modes). The user may define the upward touch orientation of his or her registered finger 1 (or other fingers) to correspond to the user mode, and define the leftward touch orientation to the guest mode (or other non-owner usage modes).

In the screen-off state, when the finger upwardly touches the fingerprint sensor, the screen may be directly lit on and the user mode is entered; and when the finger leftwardly touches the fingerprint sensor, the guest mode is entered. In the screen-on state, the above functions may be likewise implemented.

The above described system modes are not limited to the user mode and the guest mode, but may be other system modes defined according to categorization of other characteristics, for example, an elder mode, a simplified mode, a child mode and the like. In addition, the touch orientation of the finger is not limited to the upward touch, the leftward touch, the rightward touch and the downward touch.

With respect to the dialup application, if it is identified that a fingerprint template matching with the input fingerprint information is present in the fingerprint database, a telephone number corresponding to the identified fingerprint template is dialed.

Further, the user may set different touch orientations of the finger in relative to the fingerprint sensor to correspond to different numbers. For example, an identification of upward touch of the finger 1 corresponds to a telephone number 1; and an identification of leftward touch of the finger 1 corresponds to a telephone number 2. When a call needs to be made, the user may make the corresponding finger touch the fingerprint sensor according to the corresponding touch orientation, and upon identification by the system, the correspondingly telephone number may be directly dialed through.

Herein, the telephone number may be dialed anytime when necessary, which is not limited to the scenario of whether the device is the screen-on state or the screen-off state.

With respect to the operating system application, if it is identified that a fingerprint template matching with the input fingerprint information is present in the fingerprint database, an operating system or a ROM associated with the identified fingerprint template is started.

Some mobile phones are installed with different operating systems (or ROMs), and the user may set different fingerprints to correspond to different operating systems (or ROMs). Further, different operating systems (or ROMs) are launched in combination with different fingerprint orientation information. For example, an upward touch on the fingerprint sensor by the finger 1 corresponds to an operating system 1 (or a ROM 1), and a leftward touch on the fingerprint sensor by the finger 1 corresponds to an operating system 2 (or a ROM 2). When the operating system (or the ROM) needs to be switched or an operating system (or a ROM) needs to be loaded, the user may select different operating systems (or ROMs) to start by using the registered finger to touch on the fingerprint sensor with different touch orientations.

The above described operating system switching may be performed where necessary, which is not limited to the scenario of whether the device is the screen-on state or the screen-off state.

With respect to a system theme application, if it is identified that a fingerprint template matching with the input fingerprint information is present in the fingerprint database, system theme information associated with the identified fingerprint template is loaded.

Some mobile phones are provided with different system themes (different interface styles, background styles and the like). Further, the user may set different fingerprint touch orientations to correspond to different system themes (interface styles, background styles and the like). For example, an upward touch on the fingerprint sensor by the finger 1 corresponds to a system subject 1 (or an interface style, a background style and the like), and a leftward touch on the fingerprint sensor by the finger 1 corresponds to a system subject 2 (or an interface style, a background style and the like). When the system theme (or the interface style, the background style and the like) needs to be switched or a system theme (or an interface style, a background style and the like) needs to be loaded, the user may select different system themes (or interface styles, background styles and the like) by using the finger to touch on the fingerprint sensor with different touch orientations.

Likewise, the system subject is switched anytime, which is not limited to the scenario of whether the device is the screen-on state or the screen-off state.

It is understandable to those skilled in the art that all or partial steps of the method described in the above embodiments can be implemented by controlling relevant hardware by programs. The programs may be stored in a computer readable storage medium. The storage medium may be a read only memory (ROM), random access memory (RAM), a magnetic disk or a compact disc read-only memory (CD-ROM).

FIG. 2 is a structural principle diagram of a system for processing input fingerprint information according to an embodiment of the present disclosure. For ease of description, only portions relevant to the present disclosure are illustrated in FIG. 2. The system for processing input fingerprint information may be a software unit, a hardware unit or a software-hard hybrid unit that is built in a mobile terminal supporting the fingerprint identification function.

Referring to FIG. 2, the system for processing input fingerprint information includes a database establishing module 21, a fingerprint information identifying module 22 and an operating executing module 23. The fingerprint database establishing module 21 is configured to register fingerprint templates and set each fingerprint template to be associated with a corresponding application operation ; the fingerprint information identifying module 22 is configured to, when it is scanned that fingerprint information is input, identifying whether a fingerprint template matching with the input fingerprint information is present in the fingerprint database; and the operation executing module 23 is configured to, if it is identified that a fingerprint template matching with the input fingerprint information is present in the fingerprint database, perform the application operation associated with the identified fingerprint template.

Further, the fingerprint template further includes orientation information of the fingerprint; and the fingerprint information identifying module 22 is further configured to, when it is scanned that fingerprint information is input, identifying whether a fingerprint template matching with both the input fingerprint information and the orientation information is present in the fingerprint database.

As described above, the fingerprint information identifying module 21 may perform the operation in a screen-on state, a standby screen-off state, an unlocked state or a locked state; and when performing an operation in the standby screen-off state, the operation executing module 23 firstly lights up the screen and then performs the application operation associated with the fingerprint template.

When the application operation associated with the fingerprint template is an APP application, the operation executing module 23 is further configured to, if it is identified that a fingerprint template matching with the input fingerprint information is present in the fingerprint database, start the APP application associated with the identified fingerprint template.

When the application operation associated with the fingerprint template is an application regarding a working mode, the working mode including a owner mode and a non-owner mode comprising different authorities, the operation executing module 23 is further configured to: if it is identified that a fingerprint template matching with the input fingerprint information is present in the fingerprint database and the fingerprint information corresponds to the owner mode, enter the owner mode; if it is identified that a fingerprint template matching with the input fingerprint information is present in the fingerprint database and the fingerprint information corresponds to the non-owner mode, enter the non-owner mode; and if it is identified that no fingerprint template matching with the input fingerprint information is present in the fingerprint database, refuse to enter the system or enter a predetermined system mode.

When the application operation associated with the fingerprint template is a dialup application, the operation executing module 23 is further configured to, if it is identified that a fingerprint template matching with the input fingerprint information is present in the fingerprint database, dial a telephone number corresponding to the identified fingerprint template.

When the application operation associated with the fingerprint template is an operating system application, the operation executing module 23 is further configured to, if it is identified that a fingerprint template matching with the input fingerprint information is present in the fingerprint database, start an operating system or a ROM associated with the identified fingerprint template.

When the application operation associated with the fingerprint template is a system theme application, the operation executing module 23 is further configured to, if it is identified that a fingerprint template matching with the input fingerprint information is present in the fingerprint database, load system theme information associated with the identified fingerprint template.

In conclusion, according to the present disclosure, based on the fingerprint identification technology, a plurality of application manners associated respectively with various fingerprint templates are proposed according to the actual usage scenario of the user, thereby improving the convenience, quickness and security performance of the mobile phone during use.

The above descriptions are merely preferred embodiments of the present disclosure, but not intended to limit the present disclosure. Any modification, equivalent replacement, and improvement made without departing from the spirit and principle of the present disclosure shall fall within the protection scope of the present disclosure.

What is claimed is:

1. A method for processing input fingerprint information, comprising:
a fingerprint information identification step: when it is scanned that fingerprint information is input, identifying whether a fingerprint template matching with the input fingerprint information is present in a fingerprint database, wherein the fingerprint database comprises a plurality of pre-registered fingerprint templates, each fingerprint template being associated with an application operation; and
an operation execution step: if it is identified that a fingerprint template matching with the input fingerprint information is present in the fingerprint database, performing the application operation associated with the identified fingerprint template.

2. The method for processing fingerprint input information according to claim 1, wherein the fingerprint information identification step is performed in one of a screen-on state, a standby screen-off state, an unlocked state and a locked state; and when the fingerprint identification step is performed in the standby screen-off state, the operation execution step comprises lighting up a screen firstly and then performing the application operation associated with the fingerprint template.

3. The method for processing input fingerprint information according to claim 1, wherein the fingerprint template further comprises fingerprint orientation information; and
the fingerprint information identification step comprises: when it is scanned that fingerprint information is input, identifying whether a fingerprint template matching with both the input fingerprint information and the fingerprint orientation information thereof is present in the fingerprint database.

4. The method for processing input fingerprint information according to claim 1, wherein the application operation associated with the fingerprint template is an APP application, and the operation execution step comprises:
if it is identified that a fingerprint template matching with the input fingerprint information is present in the fingerprint database, starting the APP application associated with the identified fingerprint template.

5. The method for processing input fingerprint information according to claim 1, wherein the application operation associated with the fingerprint template is an application regarding a working mode, the working mode comprising an owner mode and a non-owner mode comprising different authorities and the operation execution step comprises:
if it is identified that a fingerprint template matching with the input fingerprint information is present in the fingerprint database and the fingerprint information corresponds to the owner mode, entering the owner mode;
if it is identified that a fingerprint template matching with the input fingerprint information is present in the fingerprint database and the fingerprint information corresponds to the non-owner mode, entering the non-owner mode; and
if it is identified that no fingerprint template matching with the input fingerprint information is present in the fingerprint database, refusing to enter the system or entering a predetermined system mode.

6. The method for processing input fingerprint information according to claim 1, wherein the application operation associated with the fingerprint template is a dialup application, and the operation execution step comprises:
if it is identified that a fingerprint template matching with the input fingerprint information is present in the fingerprint database, dialing a telephone number corresponding to the identified fingerprint template.

7. The method for processing input fingerprint information according to claim 1, wherein the application operation associated with the fingerprint template is an operating system application, and the operation execution step comprises:
if it is identified that a fingerprint template matching with the input fingerprint information is present in the fingerprint database, starting an operating system or a ROM associated with the identified fingerprint template.

8. The method for processing input fingerprint information according to claim 1, wherein the application operation associated with the fingerprint template is a system theme application, and the operation execution step comprises:
if it is identified that a fingerprint template matching with the input fingerprint information is present in the fingerprint database, loading system theme information associated with the identified fingerprint template.

9. A system for processing input fingerprint information, comprising:
a fingerprint database establishing module, configured to register fingerprint templates and set each fingerprint template to be associated with an application operation;
a fingerprint information identifying module, configured to, when it is scanned that fingerprint information is input, identifying whether a fingerprint template matching with the input fingerprint information is present in the fingerprint database; and
an operation executing module, configured to, if it is identified that a fingerprint template matching with the input fingerprint information is present in the fingerprint database, perform the application operation associated with the identified fingerprint template.

10. The system for processing input fingerprint information according to claim 9, wherein the fingerprint information identifying module performs the operation in one of a screen-on state, a standby screen-off state, an unlocked state and a locked state; and when performing an operation in the standby screen off state, the operation executing module firstly lights up a screen and then performs the application operation associated with the fingerprint template.

11. The system for processing input fingerprint information according to claim 9, wherein the fingerprint template further comprises fingerprint orientation information; and
the fingerprint information identifying module is further configured to, when it is scanned that fingerprint information is input, identifying whether a fingerprint template matching with both the input fingerprint information and orientation thereof information is present in the fingerprint database.

12. The system for processing input fingerprint information according to claim 9, wherein the application operation associated with the fingerprint template is an APP application, and the operation execution module is further configured to, if it is identified that a fingerprint template matching with the input fingerprint information is present in the fingerprint database, starting the APP application associated with the identified fingerprint template.

13. The system for processing input fingerprint information according to claim 9, wherein the application operation associated with the fingerprint template is an application regarding a working mode, the working mode comprising an owner mode and a non-owner mode comprising different authorities; and
the operation executing module is further configured to: if it is identified that a fingerprint template matching with the input fingerprint information is present in the fingerprint database and the fingerprint information corresponds to the owner mode, enter the owner mode;
if it is identified that a fingerprint template matching with the input fingerprint information is present in the fingerprint database and the fingerprint information corresponds to the non-owner mode, enter the non-owner mode; and
if it is identified that no fingerprint template matching with the input fingerprint information is present in the fingerprint database, refuse to enter the system or enter a predetermined system mode.

14. The system for processing input fingerprint information according to claim 9, wherein the application operation associated with the fingerprint template is a dialup application, and the operation execution module is further configured to, if it is identified that a fingerprint template matching with the input fingerprint information is present in the fingerprint database, dial a telephone number corresponding to the identified fingerprint template.

15. The system for processing input fingerprint information according to claim 9, wherein the application operation associated with the fingerprint template is an operating system application, and the operation execution module is further configured to, if it is identified that a fingerprint template matching with the input fingerprint information is present in the fingerprint database, start an operating system or a ROM associated with the identified fingerprint template.

16. The system for processing input fingerprint information according to claim 9, wherein the application operation associated with the fingerprint template is a system theme application, and the operation execution module is further configured to, if it is identified that a fingerprint template matching with the input fingerprint information is present in the fingerprint database, load system theme information associated with the identified fingerprint template.

17. A mobile terminal, comprising
a non-transitory memory storage comprising instructions; and
one or more processors in communication to the memory, wherein the one or more processors execute the instructions to:
identify, when fingerprint information is input, whether a fingerprint template matching with the input fingerprint information is present in a fingerprint database, wherein the fingerprint database comprises a plurality of pre-registered fingerprint templates, each fingerprint template being associated with an application operation; and
perform, when one of the fingerprint templates matches the input fingerprint information, the application operation associated with the identified fingerprint template.

18. The mobile terminal according to claim 17, wherein the instruction to identify whether a fingerprint template matching with the input fingerprint information when the terminal device is in one of a screen-on state, a standby screen-off state, an unlocked state and a locked state.

19. The mobile terminal according to claim 18, wherein when the instruction to identify is performed in the standby screen-off state, a screen of the mobile terminal is lit up before the application operation associated with the fingerprint template being performed.

20. The mobile terminal according to claim 17, wherein the fingerprint template further comprises fingerprint orientation information; and when one of the fingerprint templates of the fingerprint database matches with the input fingerprint information, and the fingerprint orientation information of the one of the fingerprint templates matches the orientation information of the input fingerprint information, the one of the fingerprint templates is identified as matching with the input fingerprint information.
